(19) United States
(12) Patent Application Publication
(10) Pub. No.: US 2012/0151367 A1
(43) Pub. Date: Jun. 14, 2012

(54) METHOD AND APPARATUS FOR REGISTERING A CONTENT PROVIDER CHANNEL FOR RECOMMENDATION OF CONTENT SEGMENTS

(75) Inventor: Sailesh Sathish, Tampere (FI)

(73) Assignee: Nokia Corporation

(21) Appl. No.: 12/965,336

(22) Filed: Dec. 10, 2010

(51) Int. Cl. G06F 15/16; G06F 3/01

(52) U.S. Cl. 715/738; 709/217

(57) ABSTRACT

An apparatus may include a recommendation module configured to recommend a group of content segments recommended for a user by one or more content channels. A profile determiner may determine a user profile, which may be used to recommend the content channels. The user profile may include contextual characteristics, which may be determined by a contextual characteristic determiner. Further, the apparatus may include a content provider registrar configured to register a content provider channel. Thereby, the apparatus may provide for recommendation of one or more of the content segments by the content provider channel. Further, the content provider channel may be provided access to the user profile. Accordingly, the content provider channel may function in the same manner as the other content channels in some instances. Conversely, the content provider registrar may provide for download of an installation package and confirmation of compatibility in another instance.

### TECHNOLOGICAL FIELD

An example embodiment of the present invention relates generally to techniques for registering content provider channels and, more particularly, relates to an apparatus, a method and a computer program product for registering content provider channels recommendation of content segments.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels may utilize mobile terminals to communicate with other individuals or contacts, receive services and/or share information, media and other content.

Some of the technologies which are becoming more popular are those of location based services and other personalized services. In this regard, some technologies may provide users of properly equipped mobile terminals with content that is specific to the present location of the user. Thus, for example, the user may be provided with weather information relating to the user's present location. Thereby, content may be provided to the user which may be relevant to the user's interests and current context. However, it may still be possible to improve the provision of content to users.

### BRIEF SUMMARY

A method, apparatus and computer program product are therefore provided that may provide for inclusion of a content provider channel in a group of content channels.

In an example embodiment, an apparatus comprises at least one processor and at least one memory including computer program code, the at least one memory and the computer program code configured to, with the processor, cause the apparatus to provide for output of a group of content segments recommended for a user by one or more content channels. The apparatus may additionally register a content provider channel. Thereby, the apparatus may provide for recommendation of one or more of the content segments by the content provider channel.

In an additional example embodiment a method comprises providing for output of a group of content segments recommended for a user by one or more content channels. The method may additionally include registering a content provider channel via a processor. Further, the method may include providing for recommendation of one or more of the content segments by the content provider channel.

In a further example embodiment a computer program product comprises at least one computer-readable storage medium having computer-executable program code portions stored therein, the computer-executable program code portions comprising program code instructions providing for output of a group of content segments recommended for a user by one or more content channels. The computer program product may further comprise program code instructions for registering a content provider channel. Additionally, the computer program product may include program code instructions providing for recommendation of one or more of the content segments by the content provider channel.

In a further example embodiment an apparatus comprises means providing for output of a group of content segments recommended for a user by one or more content channels. The apparatus may further include means for registering a content provider channel. Also, the apparatus may comprise means providing for recommendation of one or more of the content segments by the content provider channel.

In some embodiments an installation package may be downloaded. Compatibility of the content provider channel may be determined based on the installation package. Further, in some embodiments the content provider channel may be registered with a channel registry. Also, the content provider channel may be authenticated. The content provider channel may be provided with access to a user profile relating to the user in some embodiments so as to provide for recommendation of one or more of the content segments based at least in part on the user profile. Additionally, the content provider channel may be recommended.

User interface circuitry may also be provided which is configured to facilitate user control of at least some functions through use of a display. The user interface circuitry may cause at least a portion of a user interface to be displayed on the display to facilitate user control of at least some functions. Accordingly, embodiments of the present invention may provide a way to add a content provider channel to a group of content channels. Further, the content provider channels may be added regardless of the type of content relating thereto. Thereby, a user may be provided with additional content channels.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to register a content provider channel for recommendation of content segments according to an example embodiment of the present invention;

FIG. 3 illustrates a schematic block diagram of an embodiment of the apparatus of FIG. 2 including additional components configured to register a content provider channel for recommendation of content segments according to an example embodiment of the present invention; and

FIG. 4 illustrates a flowchart of the operations performed in registering a content provider channel for recommendation of content segments according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a computer-readable storage medium, which refers to a non-transitory, physical storage medium (e.g., volatile or non-volatile memory device), can be differentiated from a computer-readable transmission medium, which refers to an electromagnetic signal.

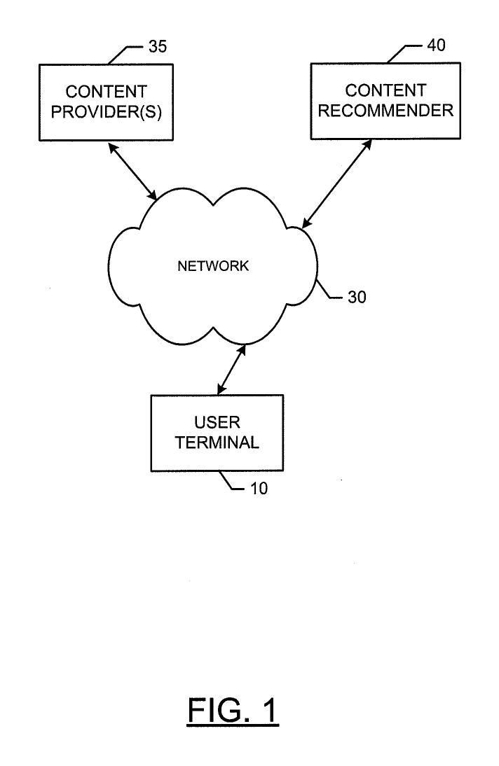

As indicated above, some embodiments of the present invention may be employed in methods, apparatuses and computer program products configured to register a content provider channel for recommendation of content segments. Thereby, a new content channel may be created. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as, for example, personal digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The user terminal 10 may be configured to output text, pictures, data, audio, video, and/or various other embodiments and media formats of content segments. In some embodiments the content may be provided to the user terminal 10 by one or more content providers 35. In some embodiments one or more of the content providers 35 may be embodied as a server, server bank or other computer or other computing device or node configured to provide content segments to the user terminal 10. Each of the content providers 35 may have any number of functions or associations with various services. As such, for example, one or more of the content providers 35 may be a platform such as a dedicated server (or server bank), or one or more of the content providers may be a backend server associated with one or more other functions or services. Thus, the content providers 35 may provide content to the user terminal 10 for use by a user thereof.

In some embodiments the system may further comprise a content recommender 40. In some embodiments the content recommender 40 may be embodied as a server, server bank or other computer or other computing device or node configured to recommend one or more content segments and/or content channels for the user of the terminal 10. The content recommender 40 may have any number of functions or associations with various services. As such, for example, the content recommender 40 may be a platform such as a dedicated server (or server bank), or the content recommender may be a backend server associated with one or more other functions or services.

In some embodiments the system may provide for output of a group of content segments recommended for a user by one or more content channels. In this regard, the content recommender 40 may provide for output of the content segments by recommending the content segments, and the user terminal 10 may provide for output of the content segments by displaying or otherwise outputting the content segments. A content channel, as used herein, may refer to a source or collection of content segments that relate to one or more topics. For example, content channels may provide content segments relating to sports, news, nearby restaurants, nearby events, etc. in one or more of various types of media formats. However, one or more content channels may be generic, and thus the channel may provide random content segments. In some embodiments the content channels may output content segments on the user terminal 10 in the form of Uniform Resource Locators (URLs) that the user may select. A group of content segments, as used herein, may refer to one or more content segments. For example, the content channels may recommend a group of content segments comprising a list of URLs, although the content segments may be outputted in other forms in other embodiments. Thus, the user may be provided with a plurality of content channels for selection. Thereby the user may select one or more of the content channels to receive content segments associated therewith. In this regard, content segments may be provided in any of various types of media formats for content such as pictures, video, audio, text, etc. Further, content segments may include combinations of different types of content, such as web pages. Also, different content channels may provide content segments in different media formats in some embodiments. For example, one content channel may provide content segments in the form of text, whereas another content channel may provide content segments in the form of videos.

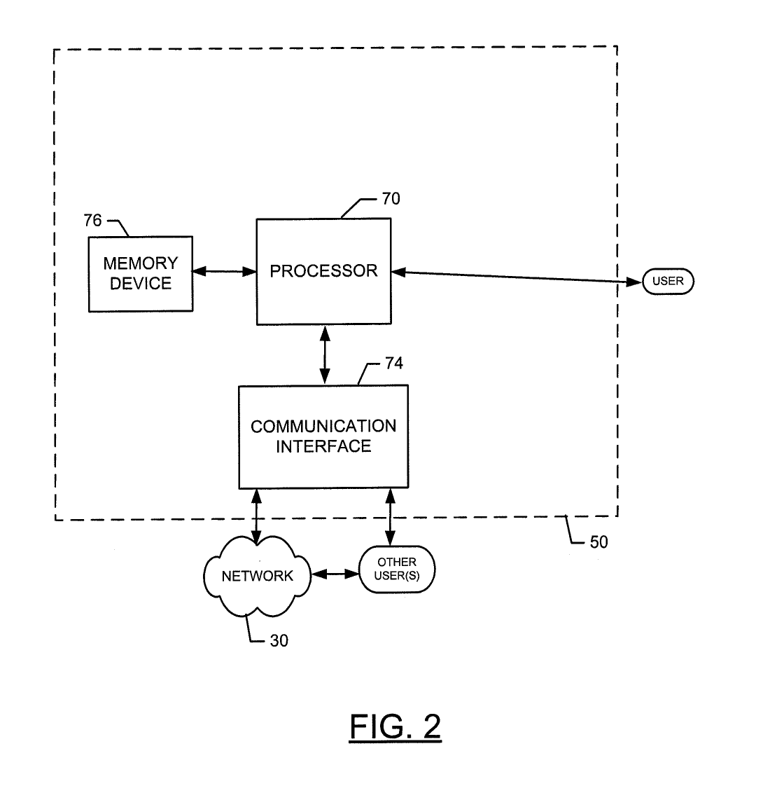

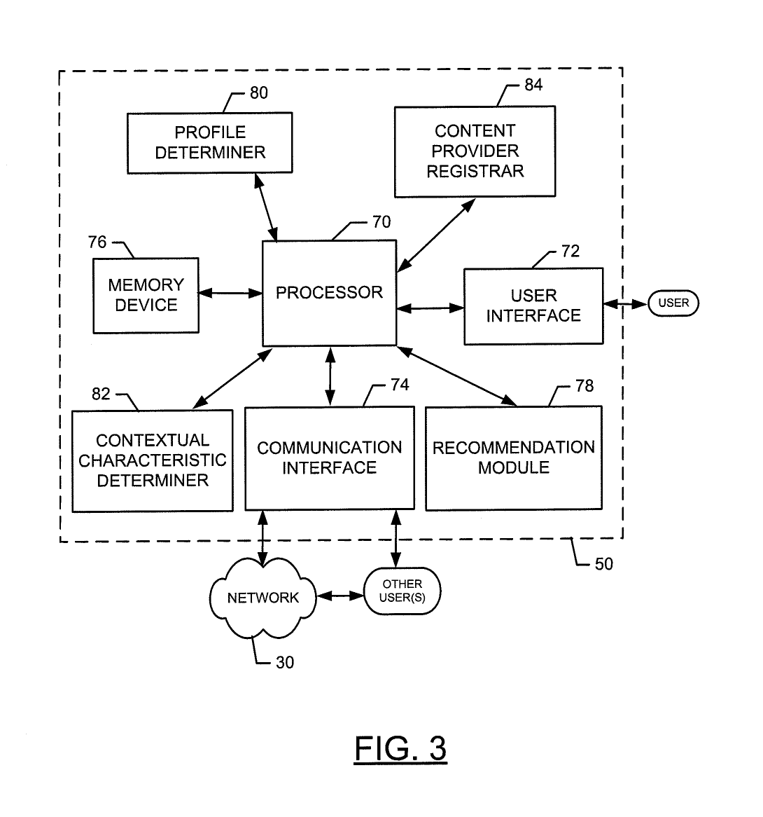

In example embodiments illustrated in FIGS. 2 and 3, an apparatus 50 is provided that may be employed by devices performing example embodiments of the present invention. The apparatus 50 may be embodied, for example, as any device hosting, including, controlling, comprising, or otherwise forming a portion of the user terminal 10, the content providers 35, and/or the content recommender 40. However, embodiments may also be embodied on a plurality of other devices such as for example where instances of the apparatus 50 may be embodied on the network 30. As such, the apparatus 50 of FIGS. 2 and 3 is merely an example and may include more, or in some cases less, than the components shown in FIGS. 2 and 3.

With further regard to FIGS. 2 and 3, the apparatus 50 may be configured to provide for recommendation of one or more content segments by a content provider channel. A content provider channel may comprise a content channel that provides content segments from a content provider 35 or other content source. Thus, content provider channels may comprise new content channels that are previously unregistered for output on the user terminal 10 and/or other devices. For example, some of the content providers 35 may be configured to provide content segments, but they may not be registered to provide the content through a content channel. Accordingly, the apparatus 50 may register content provider channels such that additional content channels may be provided to the user.

As depicted in FIG. 2, the apparatus 50 may include or otherwise be in communication with a processor 70, a communication interface 74, and a memory device 76. The memory device 76 may include non-transitory and tangible memory that may be, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

As mentioned above, the apparatus 50 may, in some embodiments, be a user terminal or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a user terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

The communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

As mentioned above, embodiments of the apparatus 50 may include more, or in some cases less, than the components shown in FIG. 2. In this regard, FIG. 3 illustrates an embodiment of the apparatus 50 comprising additional components configured to register a content provider channel and provide for recommendation of one or more content segments by the content provider channel. The apparatus 50 may include or otherwise be in communication with the processor 70, the communication interface 74, and the memory device 76 as described above with respect to FIG. 2. Note that a module, as may be used herein, need not necessarily be modularized, but instead may be distributed in some embodiments. Thus, the term module is only used to designate the functions associated with or performed by the respective module.

In some embodiments the apparatus 50 may further comprise a user interface 72. The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (for example, software and/or firmware) stored on a memory accessible to the processor 70 (for example, memory device 76, and/or the like).

In some embodiments the apparatus 50 may comprise a recommendation module 78. The processor 70 may be embodied as, include or otherwise control the recommendation module 78. The recommendation module 78 may be configured to provide for output of a group of content segments recommended for a user by one or more content channels. However, the specific functions of the recommendation module 78 may depend on the particular implementation of the recommendation module. For example, when all or a part of the apparatus 50 is embodied on the user terminal 10, the recommendation module 78 may be configured to issue a request for content channels and/or content segments. In some embodiments the request may be issued in the form of a Hypertext Transfer Protocol Secure (HTTPS) request. Further, in some embodiments the request may include all or part of a user profile of the user, which may include information relating to the user preferences and current contextual characteristics of the user.

In this regard, in some embodiments the apparatus 50 may further include a profile determiner 80. The processor 70 may be embodied as, include or otherwise control the profile determiner 80. The profile determiner 80 may be configured to determine a user profile. In this regard, the user profile may in some embodiments comprise a static portion and a dynamic portion. When the user profile comprises a dynamic portion, the user profile may be referred to as a dynamic user profile. The static portion of the user profile may comprise information such as the nationality, preferred language, age, sex, etc. of the user. Thus, the static portion of the user profile may include information that may stay substantially the same for extended periods of time or that may be easily updated. For example, age may be easily updated if the user's birthday is known. Therefore, the profile determiner 80 may determine the static portion of the user profile by requesting and receiving user entry of basic user information.

Whereas the static portion of the user profile may include information that is unlikely to change frequently, the dynamic portion of the user profile may include information that is more likely to change on a relatively more frequent basis. In this regard, it may be inconvenient for a user to continually update the dynamic portion of the user profile with information relating to, for example, musical preferences and current location of the user. Therefore, the profile determiner 80 may in some embodiments attempt to infer some user preferences in order to create the dynamic portion of the user profile.

In order to determine the dynamic portion of the user profile, the apparatus 50 may further comprise a contextual characteristic determiner 82. The processor 70 may be embodied as, include or otherwise control the contextual characteristic determiner 82. The contextual characteristic determiner 82 may be configured to determine one or more contextual characteristics. Contextual characteristics, as used herein, refer to the context of the user and/or the apparatus 50, and thus contextual characteristics may include the present time, location, activity, etcetera of the user and/or the apparatus. Accordingly, for example, the contextual characteristic determiner 82 may determine that the user is presently at home, outside walking, or riding a bus. Information relating to the location of the user may, for example, be provided by a GPS module, though location information may additionally or alternatively be provided through other means such as triangulation using cell phone towers in some embodiments. Thus, the apparatus 50 may determine one or more contextual characteristics.

The profile determiner 80 may thereby use the contextual characteristics of the user and/or apparatus 50 as determined by the contextual characteristic determiner 82 to determine the dynamic portion of the user profile. In this regard, the profile determiner 80 may determine the dynamic portion of a dynamic user profile from a user action and from a contextual characteristic associated with the user action. For example, a user action may comprise listening to jazz music using the apparatus 50 when the apparatus is embodied in the user terminal 10. The profile determiner 80 may thus combine the user action with the contextual characteristics associated with this user action to determine the dynamic portion of the user profile. For example, the user may tend to listen to jazz music between the hours of 7 PM and 8 PM while riding the bus home. Therefore, the profile determiner 80 may infer that the user likes to listen to jazz in the evening and/or while riding the bus, and thus this information may be added by the profile determiner to the dynamic portion of the user profile. The profile determiner 80 may also directly add contextual characteristic information provided by the contextual characteristic determiner 82 to the user profile in some embodiments. For example, contextual characteristics describing the present location of the user may be included in the user profile.

Note that in some instances a user action may include something the user did not do. By way of example, a user may tend to not answer calls when the user is driving. In this regard, the user action may comprise not answering calls, and the contextual characteristic may comprise driving a car. Accordingly, the profile determiner 80 may build the dynamic portion of the user portion with inferred user preferences. Therefore, the user may not have to manually enter all of his or her user preferences, which may in some instances be complicated and/or frequently changing.

Thus, the recommendation module 78 may include some or all of the user profile information in the request for content channels and/or content segments. However, as noted above, the function of the recommendation module 78 may vary depending on the particular implementation thereof. In this regard, while the recommendation module 78 may issue the request for content in instances in which some or all of the apparatus 50 is embodied on the user terminal 10, in embodiments in which some or all of the apparatus is embodied on the content recommender 40, the recommendation module may instead receive the request and select the group of content channels configured to recommend one or more content segments for the user of the user terminal. For example, selection of the content channels may be based on the user profile information. Further, some or all of the user profile information may be stored on the content recommender 40, so the content request need not include user profile information in all embodiments. As noted above, the user profile may include information relating to the contextual characteristics of the user and/or the apparatus 50. Thereby, in some embodiments the content segments may be recommended based on contextual characteristics and/or other user profile information.

However, the content recommender 40 may only be able to recommend content segments from content channels of which it is aware. In this regard, some of the content providers 35 may be capable of providing content segments that the user of the user terminal 10 may be interested in, but the content recommender 40 may not be aware of the content providers and/or know how to access the content segments provided therefrom. Thus in some embodiments the apparatus 50 may further comprise a content provider registrar 84. The processor 70 may be embodied as, include or otherwise control the content provider registrar 84.

The function of the content provider registrar 84 may vary depending on the particular implementation thereof. However, the content provider registrar 84 may in general be configured to register a content provider channel. In one embodiment the content provider registrar 84 and/or other parts of the apparatus 50 may be embodied on the user terminal 10. In this embodiment the user of the user terminal 10 may browse for content providers 35 (or other content sources) that are not presently configured as content channels configured to provide content segments to the user. For example, the content providers 35 may produce content that may be of interest to the user, but the recommendation module 78 may not be aware of the content providers or the content providers may not presently output content in a format configured for recommendation by the recommendation module.

In this regard, the content provider registrar 84 may allow the user to register a content provider channel associated with one of the content providers 35 (or other content source). For example, the user may browse a catalogue of content providers 35 that are known, the user may search for the content providers, or the user may access the content providers directly. The browse, search and/or direct access features may be provided by the content provider registrar 84 in some embodiments.

Thereby, the user may click on an install icon or otherwise select a feature provided by the content provider registrar 84 that is configured to cause registration of a new content channel in the form of a content provider channel. For example, the content provider registrar 84 may provide for download of an installation package from the content provider 35 to the user terminal 10. In some embodiments the installation package may define a specified structure that the content provider registrar 84 may parse. For example, in one embodiment the installation package may comprise an extensible markup language (XML) structure defining the following data structure, although various other data structures may be alternatively employed. Elements of an example installation package and descriptions thereof are listed below. The example XML structure listed below may contain contextual characteristic data under which content may be recommended to a user. This may be provided as part of an XML installation package.

<channelname>content provider channel name</channelname>

<providername>name of content provider</providername>

<contenttype>type of content</contenttype>

<category>category of content if any (for client to organize this channel with a particular category, etc.)</category>

<namespace>Any namespace content associated with the content provider<namespace>

<stylesheet>cascading style sheet (CSS) for displaying content in a provided space</stylesheet>

<authenticationmodel>model of authentication that may be updated over time</authenticationmodel>

<content-fetch-context>

<location>format</location>

<time>format</time>

<activity>activity data format and description</activity>

<others/>

</content-fetch-context>

<channel-invoke-context>context source and contextual characteristic values for invoking the content provider channel</channel-invoke-context>

<preference-format>supported preference format</preference-format>

<preference-sources namespace=“optional namespace”>supported preference types</preference-sources>

<request-section>

<URI>uniform resource locator (URI) to which requests for content are to be sent</URI>

<push-service>parameters for content push if supported</push-service>

<un-subscribe>parameters for unsubscribe (to be sent when the user unsubscribes from the content provider channel)</un-subscribe>

<mandatory-request-data>mandatory data sources that may be sent to request service, e.g., location data, time data, display size</mandatory-request-data>

<optional-request-data>optional data sources that may be sent to request service, e.g., example maximum size of the content segments, model number of the user terminal, client version number, activity data, user profile data (specific sources), etc</optional-request-data>

<request-frequency>//optional

<context-based>as defined in invoke-context</context-based>

<time-based>frequency </time-based>

<spatial-based>difference in spatial parameters</spatial-based>

</request-frequency>

</request-section>

The content provider registrar 84 may be further configured to ask for user permission to add the content provider channel to the group of content channels that output content segments. Thereby, the user may be offered an opportunity to confirm his or her selection of the content provider channel. After receipt of user permission, the content provider registrar 84 may be configured to parse the installation package described above. The content provider registrar 84 may also confirm compatibility of the content provider channel based on the installation package. For example, if the content segment format and/or other parameters are not supported by user terminal 10 (or other device embodying the apparatus 50), the content provider registrar 84 may abort registration of the content provider channel. In some embodiments the content provider registrar may also provide for output of a message to the user indicating that the content provider channel is not supported. However, in instances in which the content provider channel is supported, the apparatus 50 may provide for recommendation of one or more of the content segments by the content provider channel. For example, the content provider channel may always provide content segments in one embodiment. In other embodiments the content provider channel may be provide content segments, for example, in instances in which the content provider channel has content segments available that relate to the current contextual characteristics of the user or other user profile information.

However, as noted above, the particular functions of the content provider registrar 84 may vary depending upon the implementation thereof. For example, although the discussion provided above is generally in terms of embodiments employed on the user terminal 10, the content provider registrar 84 may additionally or alternatively be embodied on the content recommender 40. In this regard, in some embodiments registering the content provider channel may comprise registering the content provider channel with a channel registry. Thereby, for example, users may select the content provider channel from the channel registry so as to be provided with content segments therefrom as may occur with the other content channels.

In order for the content provider registrar 84 to register the content provider channel, the content provider registrar may receive information relating to the content provider 35 (or other content source) and/or the content segments provided therefrom. For example, in some embodiments the content provider 35 (or other data source) may provide registration information by accessing a URL associated with the content provider registrar 84. The registration information may in some cases include the information described above in the example installation package. Further, in some embodiments the content provider registrar 84 may be configured to provide for authentication of the content provider channel, for example, to verify the identity of the content provider 35 (or other content source). Thus, in some embodiments the content provider registrar 84 may be configured to receive and evaluate authentication information, although the apparatus 50 may comprise a separate authentication module in other embodiments.

As noted above, in some embodiments the recommendation module 78 may provide for output of content segments recommended for a user by one or more content channels. In this regard, by registering the content provider channel with the channel registry, the apparatus 50 may provide for recommendation of one or more of the content segments by the content provider channel. For example, in some embodiments, registering a content provider channel may result in automatic inclusion of content segments provided by the content provider channel in the group of content segments that are outputted. In other embodiments, the recommendation module 78 may be configured to provide for recommendation of content segments provided by the content provider channel in some specified instances. For example, the recommendation module 78 may provide for recommendation of content segments provided by the content provider channel in instances in which the content provider channel is active.

Further, in some embodiments, as noted above, the content segments selected by the content channels that are recommended may be selected based on the user profile of the user, which may include information relating to the user preferences and current contextual characteristics of the user. Thus, in some embodiments content segments may be recommended based on relatively static user profile information and/or contextual characteristics of the user and or the apparatus 50. However, in order for the content provider 35 (or other content source) relating to the content provider channel to provide content segments based on the user profile, the recommendation module 78 may need to know what information the content provider needs to select the content segments. In this regard, in some embodiments the content provider registrar 84 may be configured to receive requests for additional parameters by the content provider 35 (or other content source). Thereby, the content provider registrar 84 may provide the content provider channel with access to all or a part of a user profile relating to the user. Accordingly, the content provider channel and/or other content channels may provide for recommendation of one or more of the content segments based at least in part on the user profile. In this regard, the recommendation may be based on all or a portion of the user profile. Accordingly, for example, in some embodiments the recommendation may be based on the contextual characteristics of the user and/or apparatus 50, whereas in other embodiments the recommendation may additionally or alternatively be based on static user profile information.

In this regard, the additional parameters may in one example embodiment take the following form, although various other additional parameters in various other forms may be requested in other embodiments:

<service-request>

<recommendation>

<format>expected format of recommendation</format>

<type>type of recommendation, e.g., collaborative or rule based</type>

<content-type>content type of recommendation (e.g., books, music, etc.)</content-type>

<mandatory-sources><context>sources</context><preference>preference sources</preference>

<system-data>any system changes to accommodate</system-data>

</mandatory-sources>

<optional-sources><context>sources</context><preference>preference sources</preference>

<system-data>sources</system-data>

</optional-sources>

</recommendation>

<user-account>type of user account</user-account>

Thus, the content provider registrar 84 may, for example, allow for the registration of content provider channels with a channel registry maintained, for example, by the content recommender 40. Accordingly, in some embodiments the content provider channels may be recommended in the same manner as the other content channels, though this need not necessarily be the case. Further, the content provider registrar 84 may selectively allow access to some or all of the user profile information. Additionally, the content provider registrar 84 may provide for authentication of the content provider channel. Accordingly, user profile information may be shared in a controlled manner with a known content provider channel.

Further, the content provider channel may not be provided with user account information relating to the identity of the user in some embodiments. Thereby, anonymity of the user receiving the content channels may be preserved. Also, the content provider 35 (or other content source) may receive greater visibility to users by being included in the channel registry. Additionally, the content recommender 40 may retain control over which content providers 35 (or other content sources) are allowed to register with the channel registry. The content recommender 40 may also dynamically determine whether the content provider channel is active and thereby determine whether to provide for recommendation of content segments from the content provider channel based thereon. Thus, this calculation may occur at the content recommender 40, rather than the user terminal 10 (or other content outputting device) in some embodiments, so that the computational burden on the user terminal may be reduced. Accordingly, benefits may be provided in embodiments employing the content provider registrar 84 in the content recommender 40.

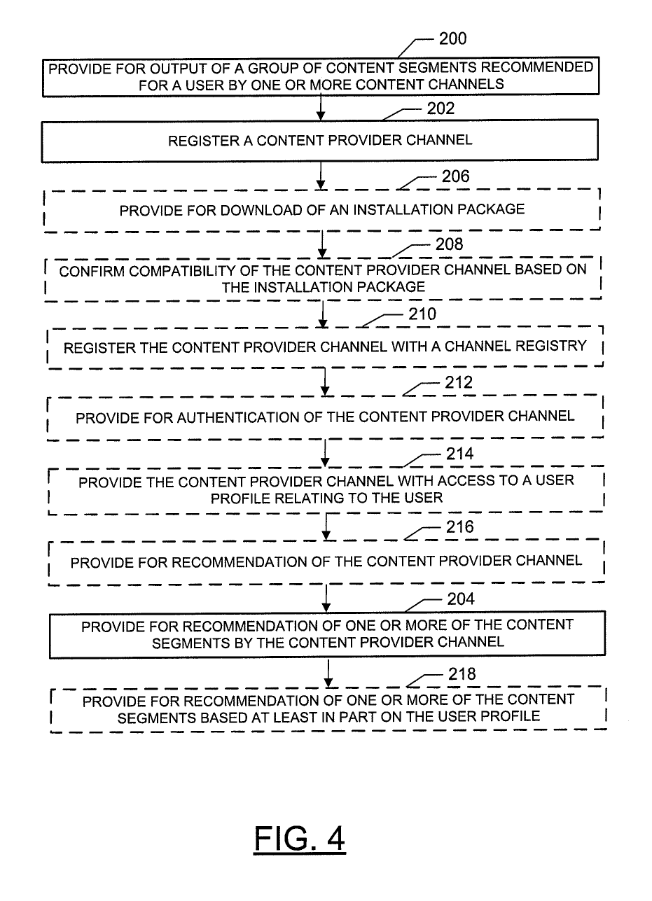

In terms of methods associated with embodiments of the present invention, the above-described apparatus 50 or other embodiments of apparatuses may be employed. In this regard, FIG. 4 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method may include providing for output of a group of content segments recommended for a user by one or more content channels at operation 200. Further, the method may include registering a content provider channel at operation 202. Also, the method may include providing for recommendation of one or more of the content segments by the content provider channel at operation 204.

In some embodiments, certain ones of the above-described operations (as illustrated in solid lines in FIG. 4) may be modified or further amplified. In some embodiments additional operations may also be included (some examples of which are shown in dashed lines in FIG. 4). It should be appreciated that each of the modifications, optional additions or amplifications may be included with the above-described operations (200-204) either alone or in combination with any others among the features described herein. As such, each of the other operations as will be described herein may be combinable with the above-described operations (200-204) either alone or with one, more than one, or all of the additional operations in any combination.

For example, the method may also include providing for download of an installation package at operation 206. Further, the method may include confirming compatibility of the content provider channel based on the installation package at operation 208. Additionally, the operation 202 of registering the content provider channel may comprise registering the content provider channel with a channel registry at operation 210. Also, as illustrated at operation 212, the method may include providing for authentication of the content provider channel. As further illustrated, the method may include providing the content provider channel with access to a user profile relating to the user at operation 214. The method may additionally include providing for recommendation of the content provider channel at operation 216. Further, the method may include providing for recommendation of one or more of the content segments based at least in part on the user profile at operation 218. For example, the recommendation may be based on the user profile at operation 218 when the content provider channel is provided with access to the user profile at operation 214.

In an example embodiment, an apparatus for performing the method of FIG. 4 and other methods described above may comprise a processor (for example, the processor 70) configured to perform some or each of the operations (200-218) described above. The processor may, for example, be configured to perform the operations (200-218) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-218 may comprise, for example, the processor 70, the user interface 72, the communication interface 74, the recommendation module 78, the profile determiner 80, the contextual characteristic determiner 82, and the content provider registrar 84, as described above. However, the above-described portions of the apparatus 50 as they relate to the operations of the method illustrated in FIG. 4 are merely examples, and it should be understood that various other embodiments may be possible.

In some embodiments the operation 200 of providing for output of a group of content segments recommended for a user by one or more content channels may be conducted by means, such as the user interface 72, the recommendation module 78, the profile determiner 80, the contextual characteristic determiner 82, and/or the processor 70. Additionally, the operation 202 of registering a content provider channel may be conducted by means, such as the communication interface 74, the content provider registrar 84, and/or the processor 70. Also, the operation 204 of providing for recommendation of one or more of the content segments by the content provider channel may be conducted by means, such as the recommendation module 78, the profile determiner 80, the contextual characteristic determiner 82, the content provider registrar 84, and/or the processor 70.

Additionally, the operation 206 of providing for download of an installation package may be conducted by means, such as the communication interface 74, the content provider registrar 84, and/or the processor 70. Also, the operation 208 of confirming compatibility of the content provider channel based on the installation package, the operation 210 of registering the content provider channel with a channel registry, and/or the operation 212 of providing for authentication of the content provider channel may be conducted by means, such as content provider registrar 84, and/or the processor 70. Additionally, the operation 214 of providing the content provider channel with access to a user profile relating to the user may be conducted by means, such as the recommendation module 78, the profile determiner 80, the contextual characteristic determiner 82, the content provider registrar 84, and/or the processor 70. Further, the operation 216 of providing for recommendation of the content provider channel may be conducted by means, such as recommendation module 78, the profile determiner 80, and/or the processor 70. Also, the operation 218 of providing for recommendation of one or more of the content segments based at least in part on the user profile may be conducted by means, such as the recommendation module 78, the profile determiner 80, the contextual characteristic determiner 82, the content provider registrar 84, and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
provide for output of a group of content segments recommended for a user by one or more content channels;
register a content provider channel; and
provide for recommendation of one or more of the content segments by the content provider channel.

2. The apparatus of claim 1, further configured to provide for download of an installation package.

3. The apparatus of claim 2, further configured to confirm compatibility of the content provider channel based on the installation package.

4. The apparatus of claim 1, further configured to register the content provider channel with a channel registry.

5. The apparatus of claim 4, further configured to provide for authentication of the content provider channel.

6. The apparatus of claim 4, further configured to provide the content provider channel with access to a user profile relating to the user; and
provide for recommendation of one or more of the content segments based at least in part on the user profile.

7. The apparatus of claim 1, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

8. A method, comprising:
providing for output of a group of content segments recommended for a user by one or more content channels;
registering a content provider channel via a processor; and
providing for recommendation of one or more of the content segments by the content provider channel.

9. The method of claim 8, further comprising providing for download of an installation package.

10. The method of claim 9, further comprising confirming compatibility of the content provider channel based on the installation package.

11. The method of claim 8, wherein registering the content provider channel comprises registering the content provider channel with a channel registry.

12. The method of claim 11, further comprising providing for authentication of the content provider channel.

13. The method of claim 11, further comprising providing the content provider channel with access to a user profile relating to the user; and
providing for recommendation of one or more of the content segments based at least in part on the user profile.

14. The method of claim 11, further comprising providing for recommendation of the content provider channel.

15. A computer program product comprising at least one computer-readable storage medium having computer-executable program code portions stored therein, the computer-executable program code portions comprising:
program code instructions providing for output of a group of content segments recommended for a user by one or more content channels;
program code instructions for registering a content provider channel; and
program code instructions providing for recommendation of one or more of the content segments by the content provider channel.

16. The computer program product of claim 15, further comprising program code instructions providing for download of an installation package.

17. The computer program product of claim 16, further comprising program code instructions for confirming compatibility of the content provider channel based on the installation package.

18. The computer program product of claim 15, wherein program code instructions for registering the content provider channel comprise program code instructions for registering the content provider channel with a channel registry.

19. The computer program product of claim 18, further comprising program code instructions providing for authentication of the content provider channel.

20. The computer program product of claim 18, further comprising program code instructions for providing the content provider channel with access to a user profile relating to the user; and
program code instructions providing for recommendation of one or more of the content segments based at least in part on the user profile.
